(19) United States
(12) Patent Application Publication
(10) Pub. No.: US 2015/0286210 A1
(43) Pub. Date: Oct. 8, 2015

(54) NUMERICAL CONTROLLER WITH DISPLAY OF A PREVIEW WHEN THE PARTS PROGRAM IS CHANGED

(71) Applicant: Siemens Aktiengesellschaft, Munchen (DE)

(72) Inventors: Christof Sinn, Muhlacker (DE); Thilo Stolper, Stuttgart (DE)

(73) Assignee: Siemens Aktiengesellschaft, Munchen (DE)

(21) Appl. No.: 14/676,446

(22) Filed: Apr. 1, 2015

(30) Foreign Application Priority Data
Apr. 2, 2014 (EP) 14163149.9

(51) Int. Cl. G05B 19/4097

(52) U.S. Cl. CPC G05B 19/4097

(57) ABSTRACT

A numerical controller executes a parts program controlling a production machine. An operator selects via a selection command a program instruction in the parts program that is parameterized with at least one parameter. The program instruction is converted into a movement of a tool processing a workpiece. Information identifying the program instruction is communicated to a CAM system which then returns data specifying a three-dimensional geometry of the workpiece commensurate with the selected program instruction and determines an image of the workpiece. The operator can change the parameters and hence also the image. Any changes of a parameter are communicated to the CAM system which then determines a changed image of the workpiece and outputs the changed image to the operator. A modified parts program corresponding to the changed program instruction can be stored upon receipt of a storage command from the operator.

### CROSS-REFERENCES TO RELATED APPLICATIONS

This application claims the priority of European Patent Application, Serial No. 14163149.9, filed Apr. 2, 2014 pursuant to 35 U.S.C. 119(a)-(d), the content of which is incorporated herein by reference in its entirety as if fully set forth herein.

### BACKGROUND OF THE INVENTION

The present invention relates to a method of operation for a numerical controller, to a computer program for executing the method of operation on a numerical controller, and to a numerical controller with a stored computer program that can be executed by the numerical controller.

The following discussion of related art is provided to assist the reader in understanding the advantages of the invention, and is not to be construed as an admission that this related art is prior art to this invention.

In ongoing operation, numerical controllers conventionally run a so-called parts program. The parts program specifies how axes of the production machine (in particular a machine tool) which are positionally-regulated and rotation-speed-regulated are controlled. Theoretically, it is possible to generate the parts program directly via the operator interface of the numerical controller. However, only a significantly restricted set of commands is available via the operator interface of the numerical controller. In practice therefore, the parts program is generated by means of a CAM system, starting from data generated by means of a CAD system. Using the CAM system, it is possible to exploit the full set of commands for the numerical controller. The CAM system can also incorporate a so-called post-processor.

As a result of the generation of the parts program by means of the CAM systems, the parts program will incorporate two types of program instruction. On the one hand the parts program contains free-form processing activities, on the other hand so-called cycles.

Free-form processing activities are processing activities in which the full set of commands of the numerical controller is used. It is not possible to program free-form processing activities by means of the restricted set of commands which can be generated via the operator interface of the numerical controller. Within a parts program, free-form processing activities are present as a sequence of individual control commands for the positionally- and rotation-speed-regulated axes of the production machine. Each of the control commands for free-form processing is a program instruction.

In the case of free-form processing activities, the sequence of individual control commands can be very long (in some cases several million control commands). On the other hand, the parts program generally no longer contains as such the parameterized specifications which underlie the sequence of individual control commands. The parameters can also no longer be extracted from the sequence of control commands. Examples of such criteria are the line spacing, the tool geometry, the processing strategy, implications of collision avoidance calculations, technological values such as for example the approach movement of the tool etc.

Cycles are the commands in the restricted command set which can be parameterized via the operator interface of the numerical controller. A cycle can also be programmed by the operator of the CAM system. In the case of a cycle, the operator of the CAM system prescribes to the CAM system just as in the case of a free-form processing activity—a number of parameters. However, unlike a free-form processing activity, the parts program generated by the CAM system does not directly contain the sequence of the associated individual control commands for the positionally—and rotation-speed-regulated axes of the production machine, but instead a sub-routine call for the cycle together with the appropriate parameterization. The conversion of the cycle into the sequence of individual control commands for the positionally—and rotation-speed-regulated axes of the production machine is in this case undertaken by the numerical controller. A cycle thus represents one single program instruction, which is converted by the numerical controller into a sequence of individual control commands.

The operator of the CAM system is generally a different person than the operator of the numerical controller. In many cases, the operator of the CAM system has none of the key technical data about the production machine which is to be controlled by means of the parts program. A consequence of this can be that the execution of the parts program by the numerical controller results in workpieces which are not correctly produced. Depending on the situation in an individual case, it may be necessary in such cases to redetermine the parts program in a fundamentally new way. In many cases, however, it is apparent to the operator of the numerical controller, on the basis of his/her knowledge of the production machine and of its key technical data, which parameters of which parameterized specification must be altered, in order to be able to produce a workpiece which it as required.

In the state of the art, the operator of the numerical controller can only carry out changes to the parts program if the section of the parts program which to be changed is present in the numerical controller in parameterized form, i.e. a parameterized cycle is concerned. In all other cases, the operator of the numerical controller must get in touch with the operator of the CAM system and inform the latter which parameters the operator wishes to have altered in which parameterized specification. The operator of the CAM system then calls up the CAM system, changes the appropriate parameterized specification and thereby recreates the parts program. The appropriately modified parts program is transmitted to the numerical controller—generally as a replacement for the original parts program.

Most recently, efforts have also been in progress to make available to the operator of the numerical controller means by which the operator can also change those sections of the parts program which are not present in a parameterized form in the numerical controller.

If the section of the parts program which is to be changed is present in the numerical controller in parameterized form, the operator of the numerical controller can make the change him/herself. In this case the operator calls up via the operator interface an output mask. In this output mask, the numerical controller outputs to the operator of the numerical controller the parameters of the appropriate cycle. In addition, the numerical controller outputs to the operator via the output mask a display of the processing which is affected by the cycle concerned. This display can be animated. The operator of the numerical controller changes the parameters and then confirms the change. Thereupon the numerical controller stores the correspondingly modified parts program.

In the prior art, the display of the processing which is effected is purely schematic in nature. It takes into account neither the positioning of the cycle concerned within the parts program nor the arrangement and orientation of the contour, produced by the processing, within the workpiece as a whole which is produced by the parts program.

The approach of the prior art is suboptimal in various respects. So, for example, it is possible that orientation-dependent parameters of a cycle which are in principle of the same type (typical example: the length and width of a rectangular contour) are mixed up. If the same cycle is used repeatedly with different parameters (for example: the same contour is to be produced at different places on the workpiece), it can in addition happen that an incorrect cycle is parameterized by mistake. Furthermore, it is not immediately apparent from the display what change will be effected on the workpiece which is to be produced by the change to the parameters of a particular cycle.

It would therefore be desirable and advantageous to obviate prior art shortcomings by giving the operator the option to make changes to parameters of selected program instructions at any time.

### SUMMARY OF THE INVENTION

According to one aspect of the present invention, a method of operating a numerical controller controlling a production machine includes:
accessing with the numerical controller a parts program to be executed by the numerical controller,
enabling an operator to issue to the numerical controller, via an operator interface, a selection command which selects in the parts program a program instruction having at least one assigned parameter,
when the parts program is executed by the numerical controller, converting the selected program instruction into a processing movement of a tool that processes a workpiece, with the processing movement depending on the at least one assigned parameter,
determining with the numerical controller at least one image of the workpiece based on data that specify at least the three-dimensional geometry of the workpiece,
outputting with the numerical controller to the operator of the numerical controller via the operator interface the at least one assigned parameter in a form that can be changed by the operator, as well as the image,
determining with the numerical controller, when an assigned parameter is changed by the operator, at least one changed image of the workpiece based on changed data that specify at least the changed three-dimensional geometry of the workpiece, and outputting the changed image to the operator of the numerical controller via the operator interface,
upon receiving from the operator a corresponding storage command, storing with the numerical controller a modified parts program that corresponds to the changed assigned parameter,
transmitting, with the numerical controller, information (ident) which identifies the selected program instruction via a computer-to-computer link directly or indirectly to a CAM system,
receiving, at the numerical controller, from the CAM system the data that specify at least the three-dimensional geometry of the workpiece, and
transmitting, with the numerical controller, when a parameter of the selected program instruction is changed, the change to the CAM system, and receiving, at the numerical controller, from the CAM system the changed data,
wherein the data and the changed data specify the three-dimensional geometry of the workpiece that results when the parts program is executed, including the selected program instruction and the changed program instruction.

On the basis of the three-dimensional image, full information is available to the operator at any time about the workpiece, as it would become up to the execution of the selected program instruction.

According to an advantageous feature of the present invention, the numerical controller may determine and output to the operator a predetermined number of images (at least one image, but possibly also several images), and the operator may no longer change the images as such. Preferably, however, the numerical controller will receive display parameters from the operator, and will determine the image and the amended image in accordance with the prescribed display parameters. In the simplest situation, the operator can in this case only choose which of several possible displays is shown to him/her, for example a cross-sectional view or a perspective view. Preferably, however, the display parameters will specify, for a cross-sectional view and/or a perspective view, how the view is scaled and/or rotated.

According to another advantageous feature of the present invention, the data and the changed data may include additional path data items, which specify a path of the tool which is processing the workpiece. In this case, the numerical controller inserts the path into the image and the amended image. The result is a simpler intuitive appreciation of the details of the situation for the user.

Advantageously, the numerical controller may also insert into the image the tool, and move it along the path. This approach improves still further the intuitive appreciation of the details of the situation.

According to another advantageous feature of the present invention, in response to control commands input by the operator, the numerical controller may stop and then resume the movement of the tool. Alternatively or additionally, the numerical controller may adjust the speed with which the tool is moved in the image as a function of control commands from the operator. By these two measures—in particular by the combination of the two measures—it is possible to investigate especially precisely any critical processing operations.

When it is possible to stop the movement of the tool relative to the workpiece, the numerical controller may advantageously receive from the operator a location along the path, and when the tool is stopped in the image it is positioned in the location received from the operator. By this means it is possible to specify in a simple way the location at which the tool is stopped in the image. The location can, in principle, be prescribed by the operator in any arbitrary way. It is especially simple if the operator marks a particular location, using a cursor or a pointer or suchlike, in the image into which the path is inserted, and either the marking as such causes the tool to be stopped at this location, or after the relevant location has been marked the tool is stopped by a separate stop command.

According to another advantageous feature of the present invention, the numerical controller may receive from the operator a control command and, depending on the control command, in the image may either moves the tool with an unchanged display of the workpiece or move the workpiece with an unchanged display of the tool.

According to another advantageous feature of the present invention, the numerical controller may process an real workpiece by executing the parts program and the numerical controller may move the tool in the image along the path which has been inserted into the image, in correspondence with the actual processing of the workpiece. By this means, the operator can observe in a simple way via the operator interface the processing of the workpiece, corresponding to its actual progress.

Advantageously, the selected program instruction in the parts program may be part of a sequence which is stored in the numerical controller in parameterized form (a cycle). Alternatively, selected program instruction may be part of a sequence which is not present in either the parts program or the numerical controller in a parameterized form (free-form processing).

According to another advantageous feature of the present invention, when a parameter of the selected program instruction is changed, the numerical controller may immediately
communicate the change to the CAM system,
receive the changed data from the CAM system,
determine the changed image of the workpiece, and
output the changed image to the operator of the numerical controller.

In this case, the result is that the image is at any time adjusted interactively to the changed parameters. Alternatively, the numerical controller may carry out this activity only after an appropriate release command has been inputted by the operator.

According to another aspect of the invention, a computer program having machine code is stored on a non-transitory computer-readable medium, wherein the machine code when loaded into a memory of a numerical controller and executed by the numerical controller, causes the numerical controller to carry out the aforedescribed method.

According to yet another aspect of the invention, a numerical controller includes a memory into which a computer program having machine code stored on a non-transitory computer-readable medium is loaded, wherein the numerical controller executes the machine code, causing the numerical controller to carry out the aforedescribed method.

For the orderly functioning of the inventive method of operation, it can be necessary in addition that the CAM system, by means of which the parts program was generated, is known to the numerical controller. It may sometimes be possible that this information is permanently stored in the numerical controller. Alternatively, the operator of the CAM system can be asked to supply the appropriate information. Preferably, the numerical controller will determine the appropriate CAM system autonomously by reference to a header in the parts program.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a conventional network of several items of equipment,

FIG. 2 shows a main program for a parts program,

FIG. 3 shows a subroutine of a parts program,

FIG. 4 shows a communication in the network in FIG. 1 according to the present invention,

FIG. 5 shows a flow diagram,

FIG. 6 shows an output mask,

FIG. 7 shows an image of a workpiece and a tool, and

FIG. 8 shows another flow diagram.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

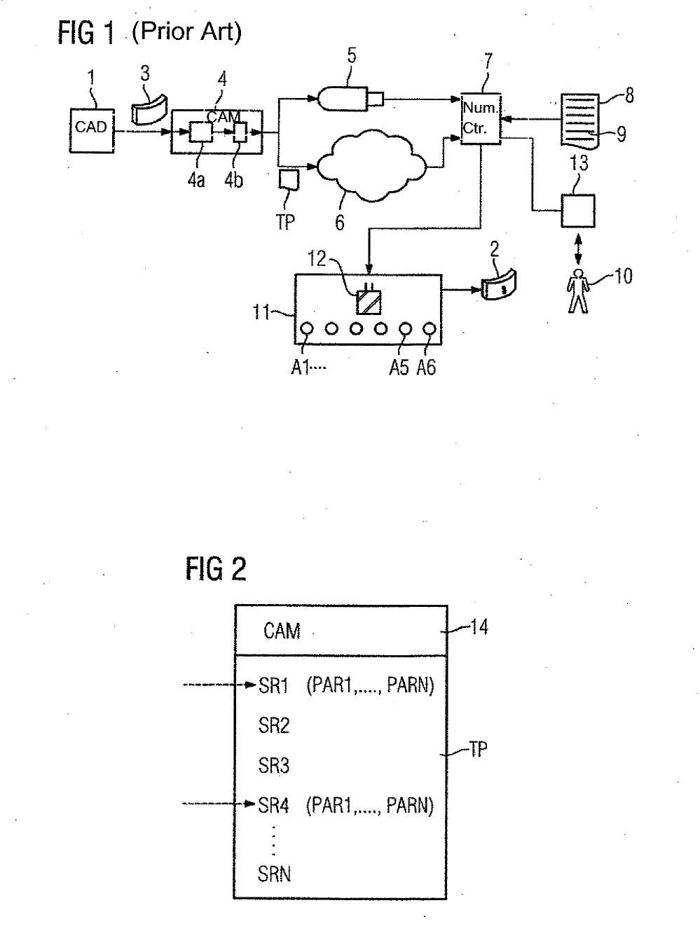

Turning now to the drawing, FIG. 1 shows a conventional network of several items of equipment, wherein a workpiece 2 which is to be produced is first specified by means of a CAD system 1. A (purely geometric) specification 3 of the workpiece 2 is passed over to a CAM system 4. The CAM system 4 generally incorporates a CAM processor 4a and a postprocessor 4b. Using the CAM system 4, a parts program TP is generated. The CAM processor 4a is responsible for a pattern of processing movements. In general, the CAM processor 4a produces, by reference to parameterized masks which are assigned to the surfaces of the workpiece 2, a sequence of tool paths. The tool paths are generally still defined independently of any controller. The postprocessor 4b converts the tool paths into a controller-specific sequence of program instructions. In its totality, the sequence of program instructions forms the parts program TP. The parts program TP is transmitted—for example via a data medium 5 or a computer-to-computer link 6—to a numerical controller 7. By this means, the numerical controller 7 has access to the parts program TP. The representation of the data medium 5 as a USB memory stick is purely by way of example. The computer-to-computer link 6 can—depending on the situation in an individual case—take the form of a LAN (=local area network), a WAN (=wide area network) or the WWW (=world wide web).

The numerical controller 7 is programmed with a computer program 8. The computer program 8 is stored internally in the numerical controller 7, for example in an EEPROM or in a flash EPROM. The computer program 8 incorporates machine code 9 which can be directly executed by the numerical controller 7. The computer program 8 is generally stored in the numerical controller 7 by the manufacturer of the numerical controller 7.

The first effect of the execution of the machine code 9 by the numerical controller 7 is that the numerical controller 7—after an appropriate control command has been issued by the user 10—executes the parts program TP. By the execution of the parts program TP, a production machine 11 is controlled by the numerical controller 7. The production machine 11 can be designed as required, for example as a machine tool with three, four, five . . . positionally-regulated axes A1 to A5. The machine tool 11 can be in the form of a cutting machine tool, a depositional machine tool or a mixed form of these two types. Execution of the parts program TP (and the corresponding control of the production machine 11) manufactures the workpiece 2.

As shown in FIG. 2, a main program for the parts program TP generally incorporates sub-routine calls SR1, SR2, . . . SRN. It can indeed consist exclusively of a sequence of sub-routine calls SR1, SR2, . . . SRN.

Some of the sub-routine calls SR1, SR2, . . . SRN—in FIG. 2 the sub-routine calls SR1 and SR4—are parameterized. These sections of the parts program TP are thus prescribed to the numerical controller 7 in parameterized form. In such a case, the associated sub-routine (a so-called cycle) is stored in the numerical controller 7 independently of the parts program TP. Within the numerical controller 7, the associated sub-routine converts the sub-routine calls SR1, SR4 concerned into a sequence of individual processing movements for the positionally-regulated axes A1 to A5 of the production machine 11. In this conversion into processing movements of the positionally-regulated axes A1 to A5, the numerical controller 7 takes into account the parameters PAR1 to PARN of the sub-routine calls SR1, SR4 concerned. Thus in the execution of the parts program TP, a program instruction is converted by the numerical controller 7 into a processing movement, which is dependent on the parameters PAR1 to PARN, of a tool 12 by means of which the workpiece 2 is processed.

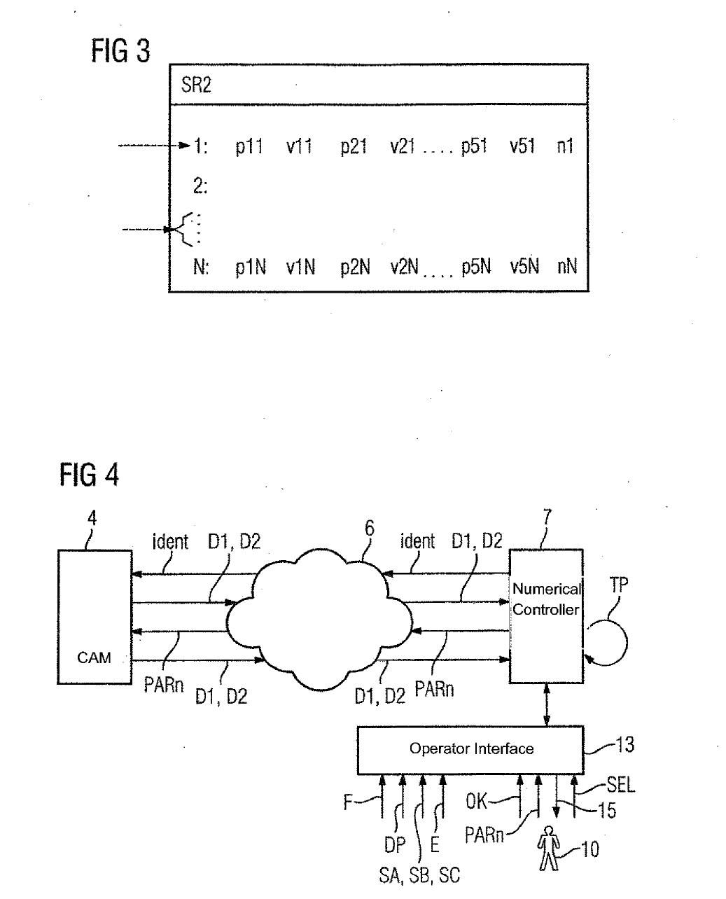

Others of the sub-routine calls SR1, SR2, . . . SRN—in FIG. 2 the sub-routine calls SR2 and SR3—are not parameterized. In this case, the associated sub-routines are components of the parts program TP. They generally consist, as shown in FIG. 3, of a sequence (mostly very long) of individual processing movements of the positionally-regulated axes A1 to A5. For each individual processing movement a position value p11 to p51, p1N to p5N, is prescribed in each case for each positionally-regulated axis A1 to A5. Further, a speed value v11 to v51, v1N to v5N is mostly prescribed for each of the positionally-regulated axes A1 to A5. Further, in many cases a rotational speed n1 to nN is prescribed for at least one rotation-speed-regulated axis A6.

It is possible that there are no unparameterized sub-routine calls SR2, SR3 as such, and instead the sequence of individual processing movements of the positionally-regulated axes A1 to A5, and if applicable also the rotation-speed-regulated axis A6, are contained in the main program for the parts program TP.

In addition to executing the parts program TP, the computer program 8, with which the numerical controller 7 is programmed, enables the operator 10 to communicate with the numerical controller 7 via an operator interface 13 of the numerical controller 7, on the basis of which the numerical controller 7 then executes activities. The corresponding method of operation, which is the subject of the present invention, is explained in more detail in conjunction with FIGS. 4 and 5.

As shown in FIGS. 4 and 5, the operator 10 can issue to the numerical controller 7 via the operator interface 13 a selection command SEL, in a step S1. By means of the selection command SEL, at least one program instruction of the parts program TP is selected. For example, the operator 10 can, as indicated in FIG. 2 by dashed arrows, select a sub-routine call SR1, SR4 which is prescribed to the numerical controller 7 in parameterized form, the associated sub-routine for which is stored in the numerical controller 7 independently of the parts program TP. Alternatively, the operator 10 can select one of the sub-routines SR2, SR3, which are not present in either the parts program TP or the numerical controller 7 in parameterized form. Equally, the operator 10 can select within one of the sub-routines SR2, SR3 one or more of the program instructions which are there. This is indicated in FIG. 3 by dashed arrows.

The numerical controller 7 knows with which CAM system 4 it should communicate. For example, appropriate information can be prescribed to the numerical controller 7 by the operator 10. The appropriate information can also be permanently stored in the numerical controller 7. Preferably, the parts program TP will, as shown in FIG. 2. contain a header 14 in which is stored the appropriate information. In this case, the numerical controller 7 can autonomously determine the associated CAM system 4, by reference to the header 14. Preferably, this CAM system 4 will be the CAM system 4 by means of which the parts program TP was generated. The information as such can be of an arbitrary nature. For example, it can be stored in the form of a URL (universal resource locator).

On the basis of the selection command SEL, the numerical controller 7 will, in a step S2 as shown in FIGS. 4 and 5, communicate to the CAM system 4, directly or indirectly via the computer-to-computer link 6, an item of information ident. This information ident identifies the at least one selected program instruction. For example, the appropriate information ident can include the line number or line numbers in the main program for the parts program TP, or a label for the appropriate sub-routine SR2, SR3 and in it the line number or line numbers.

On the basis of the ident information, the CAM system 4 determines the corresponding program instruction in the parts program TP, and the parameterization of this program instruction. The CAM system 4 determines in addition geometry data D1. This geometry data D1 specifies the three-dimensional geometry of the workpiece 2, as it would be if the processing of the workpiece 2 is executed up to—or more precisely: up to and including—the selected program instruction. The geometry data D1 which is determined is true to reality. This applies in particular for dimensions and angles. Furthermore, the geometry data D1 also specifies the contour produced by the processing in the overall context of the workpiece 2, so including for example the arrangement of the contour within the workpiece 2.

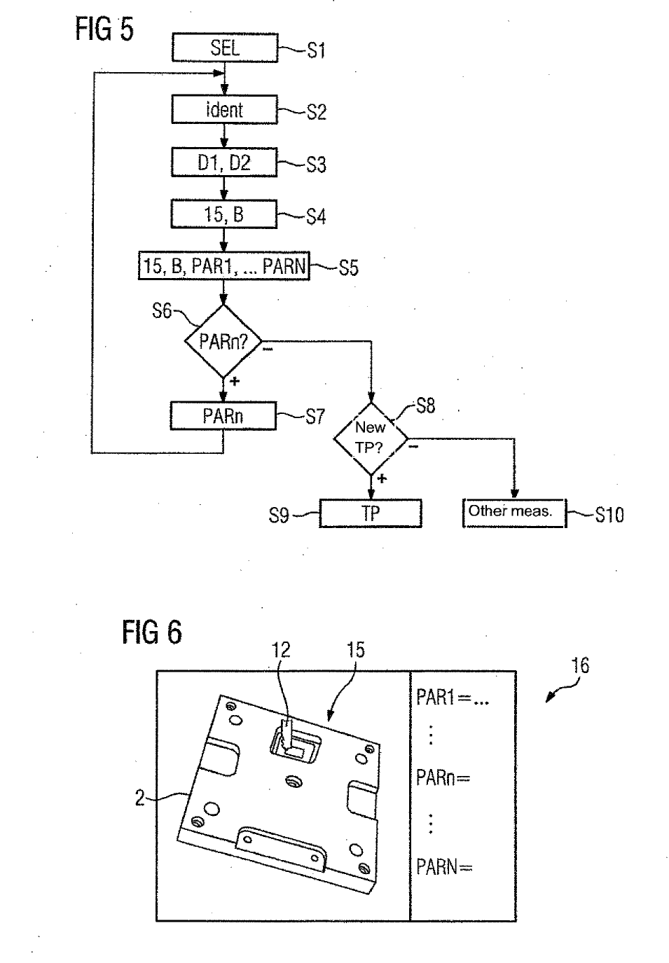

The CAM system 4 will preferably determine path data D2 in addition to the geometry data D1. The path data D2 specifies the path B along which a tool 12 (see FIG. 6) is moved along the workpiece 2 in the course of executing the program instructions, and hence of the processing of the workpiece 2. Preferably, the path data D21 will also include other parameters, such as for example an angle of approach for the tool 12 relative to the workpiece 2.

The CAM system 4 will communicate the data D1, D2 which has been determined—that is at least the geometry data D1, preferably also the path data D2—to the numerical controller 7 via the computer-to-computer link 6. The numerical controller 7 receives the data D1, D2 in a step S3.

In a step S4, the numerical controller 7 determines by reference to the geometry data D1 (at least) one image 15 of the workpiece 2. This image 15 then corresponds to a representation of the workpiece 2, as it would be if the processing of the workpiece 2 is executed up to—or more precisely: up to and including—the selected program instruction. In a step S5, the numerical controller 7 outputs the image 15 together with the parameters PAR1 to PARN to the operator 10 of the numerical controller 7, via the operator interface 13. FIG. 6 shows, purely by way of example, the corresponding display in an output mask 16.

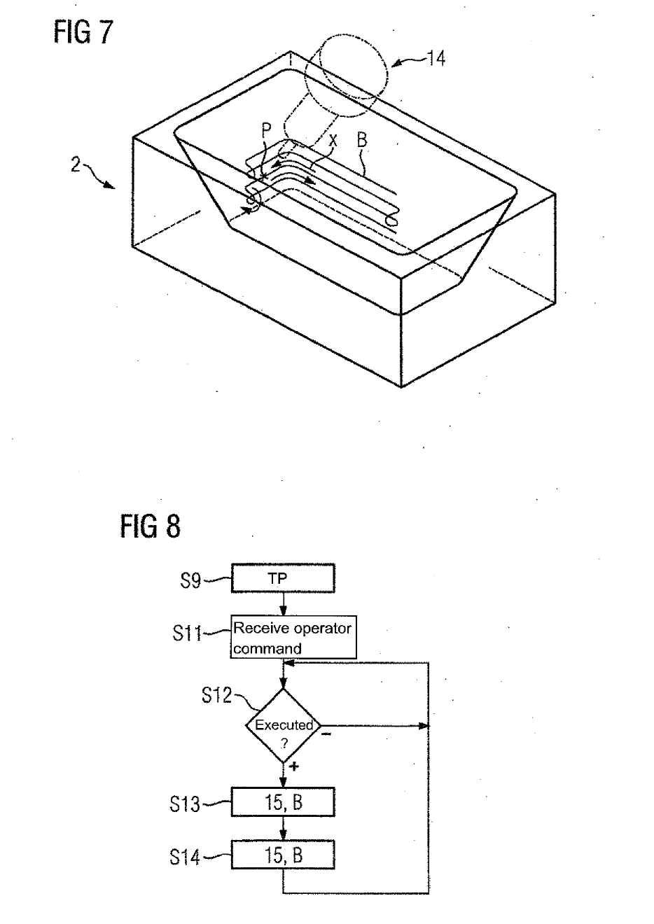

If the data D1, D2 which is communicated includes also the path data D2, the numerical controller 7 will preferably also insert the path B into the image 15, as shown in FIG. 7. It may be that the operator 10 can select and deselect the insertion of the path B.

The parameters PAR1 to PARN are output in a form in which the operator 10 can alter them. So the operator 10 can change the parameters PAR1 to PARN. The numerical controller 7 therefore checks, in a step S6, whether it has had any such change prescribed to it by the operator 10. If this is the case, that is if the operator 10 changes one of the parameters PAR1 to PARN—for example the parameter PARn —, the numerical controller 7 branches to a step S7. In step S7, the numerical controller 7 communicates the change to the CAM system 4. The numerical controller 7 then returns to step S2. The communication can take place immediately after the change has been prescribed. Alternatively, the numerical controller 7 can wait until a corresponding release command F has been issued to it by the operator 10.

In both cases, the CAM system 4 will redetermine the data D1, D2, that is at least the geometry data D1 and preferably also the path data D2. The data D1, D2 which has been re-determined corresponds to the workpiece 2, as it will be if the parts program TP is executed up to (more precisely: up to and including) the changed program instruction. In the step S3, the numerical controller 7 receives back the data D1, D2, determines the associated image 15 in step S4, and in step S5 outputs the image 15 to the operator 10 via the operator interface 13.

The image 15 which is displayed thus corresponds to the processing of the workpiece 2, as it would be if the parts program TP is executed up to the selected program instruction with the currently valid parameterization. The operator 10 of the numerical controller 7 can then if necessary undertake changes to the parameterization of the selected program instruction, and in each case will receive the true-to-reality image 15 for the corresponding processing. The operator 10 can thereby very efficiently optimize the selected program instruction.

If no change has been prescribed to the numerical controller 7 for one of the parameters PAR1 to PARN, the numerical controller 7 checks, in a step S8, whether the operator 10 has issued a storage command OK to it via the operator interface 13. If this is the case, the numerical controller 7 branches to a step S9, in which it stores the—generally amended—parts program TP. If the only change to the parts program TP is in one or more of its cycles, no communication with the CAM system 4 is required for the implementation of step S9. Otherwise, the numerical controller 7 will, as part of step S8, request the new, modified parts program TP from the CAM system 4. With the exception of the program instructions which have been changed by the operator 10, the modified parts program TP corresponds to the original parts program TP. However, in place of the originally selected program instructions, the parts program TP now contains instead the amended program instructions.

If no storage command OK has been issued to the numerical controller 7, the numerical controller 7 initiates other measures in a step S10. Step S10 can be implemented as required. It could, for example, be a termination in the sequence of activities explained above in conjunction with FIGS. 4 and 5. Alternatively, the implementation of step S10 can include a check as to whether a termination of this sort should be effected. If no termination is to be effected, the numerical controller 7 could, for example, return to step S6.

Starting from the basic forms of the present invention, explained above, various embodiments are possible. Thus it is possible, for example, that the operator 10 of the numerical controller 7 prescribes display parameters DP (see FIG. 4) and the numerical controller 7 determines the image 15—irrespective of whether the image 15 concerned is the original image or the amended image—in accordance with the prescribed display parameters DP. For example, it is possible that the operator 10 selects one of several views, for example an isometric or a dimetric view, a side view, a plan view, a section etc. It is also possible that, for example, the numerical controller 7 outputs a perspective view of the workpiece 2 via the operator interface 13 and that the operator 10 has the displayed workpiece 2 rotated continuously about an axis, wherein the operator 10 is able in addition to define the location and orientation of the axis, and possibly also a rotational speed. It is also possible that the operator 10 halts a rotation and then permits it again. Similar approaches are possible with sectional views, for which step-by-step advances in a particular direction can, for example, be realized.

As already mentioned, it is possible that the data D1, D2 includes the path data D2 in addition to the geometry data D1, and that the numerical controller 7 inserts the path B which results from it into the image 15. FIG. 7 shows by way of example such a display. It is possible, as is also shown in FIG. 7, that the numerical controller 7 inserts the tool 12 into the image 15. In this case, the numerical controller 7 will move the tool 12 along the path B. The movement of the tool 12 along the path B is indicated in FIG. 7 by inclusion in the drawing of a direction of movement x. The direction of movement x generally depends on the location of the tool 12 on the path B.

Preferably, the operator 10 of the numerical controller 7 will be able in addition to prescribe a control command SA, as shown in FIG. 4. The numerical controller 7 will, depending on the control command SA, stop the movement of the tool 12 in the image 15 which is output to the operator 10, and then start up the movement of the tool 12 again. It is possible that control commands SA which differ from each other will be used for this purpose. Alternatively, it is possible that the one and same control command SA is used for the purpose, so that the applicable instruction from the control command SA toggles in each case from one state into the other.

Alternatively or in addition to stopping and restarting the movement of the tool 12 in the image 15, it is possible that the operator 10 of the numerical controller 7 uses another) control command SB, as shown in FIG. 4, to set a speed at which the tool 12 is moved in the image 15. For example, it is possible that the operator 10 selects one of several speeds. Alternatively or additionally, it is possible that the operator 10 increases or reduces the speed—for example by means of a plus-minus function—starting from the current speed. Under some circumstances indeed even a reversal of direction can be possible.

It can furthermore be possible that, when the tool 12 is in its stopped state and starting from the current position of the tool 12, the operator 10 repositions the tool 12 in steps forward or backwards, by means of a plus-minus function.

It is further possible, for example, that the operator 10 marks a particular position P (see FIG. 7) on the path B, using a cursor or in some other way, or prescribes the particular position P to the numerical controller 7 in some other way. In this case the numerical controller 7 can react to the prescription of the position P by positioning the tool 12 at this position P. This approach can be employed irrespective of whether the tool 12 is being moved in the image 15 or not. If, at the point in time when the position P is prescribed, the tool 12 is being moved in the image 15, the tool 12 will preferably be positioned at the position P in the image 15, and then remain at the position P. So the tool 12 is stopped at the position P. However, it is in principle also possible that even though the tool 12 has been appropriately positioned, the processing movement is nevertheless continued, starting from the position.

In general, the movement of the tool 12 in the image 15 is realized by keeping the image 15 of the workpiece 2 (or, more precisely: its positioning) unchanged, and by moving the tool 12 in the image 15. The workpiece 2 thus appears to be stationary, the tool 12 to be moving. However, in principle the reverse approach is also possible, so that the tool 12 (or, more precisely: its positioning) remains unchanged in the image 15 and the workpiece 2 is moved. It is furthermore possible that the operator 10 of the numerical controller 7 issues a control command SC, as shown in FIG. 4, and that depending on this control command SC the numerical controller 7 employs one approach or the other.

FIG. 8 shows an approach which is based on the approach in FIG. 5. As shown in FIG. 8, after storing away the parts program TP in step S9, in a step S11 the numerical controller 7 receives from the operator an execution command E. On the basis of the issuing of the execution command E, the numerical controller 7 executes the parts program TP. So, using the machine tool 11, a real workpiece 2 is processed. Simultaneously with this processing, the numerical controller executes steps S12 to S14.

In step S12, the numerical controller 7 checks whether the changed program instruction (or if several program instructions have been changed, one of the changed program instructions) is being executed. If this is the case, the numerical controller 7 branches to step S13. In step S13, the numerical controller 7 determines the relevant image 15 by reference to the associated geometry data D1, and the relevant path B by reference to the associated path data D2. In step S14, the numerical controller 7 outputs to the operator 10, via the operator interface 13, the image 15 which has been determined, including the relevant path B. Into the image 15, the numerical controller 7 also inserts the tool 12, and moves it. The movement of the tool 12 will preferably be linked to the real processing of the workpiece 2. So the numerical controller 7 will preferably move the tool 12 in the image 15 in correspondence with the real processing of the workpiece 2, along the path B which has been inserted into the image 15. In doing this, depending on the choice made by the operator 10, the image 15 of the workpiece 2 (or, more precisely: its positioning) is kept unchanged and the tool 12 is moved in the image, or vice versa, the tool 12 is kept unchanged in the image 15 and the workpiece 2 is moved.

The present invention has many advantages. In particular, a realistic image 15 is available at any time to the operator 10 of the numerical controller 7, by reference to which he/she can make a realistic assessment of changes which he/she has made to a program instruction. He/she can look at the workpiece 2 from every direction. This enables the operator 10 to recognize in a rapid and simple way which program instructions are responsible for which geometric elements of the workpiece 2, and how the tool 12 can be technologically applied for this purpose. Furthermore, the direct relationship between the parameters PAR1 to PARN of a particular program instruction and the workpiece 2 or a particular geometric element of the workpiece 2, as applicable, is also apparent to the operator 10.

In summary, the present invention thus relates to the following technical matters:

A numerical controller 7 has access to a parts program TP. By executing the parts program TP, it controls a production machine 11. An operator 10 issues to the numerical controller 7 a selection command SEL, which is used to select a program instruction, in the parts program TP, which is parameterized with at least one parameter PAR1 to PARN. When the parts program TP is executed, the program instruction is converted to a processing movement, which is dependent on the parameters PAR1 to PARN, for a tool 12 which is processing the workpiece 2. The numerical controller 7 communicates to a CAM system 4 an item of information ident, which identifies the program instruction. It receives in return from the CAM system 4 data D1, D2 which specifies at least the three-dimensional geometry of the workpiece 2, as it would be if the parts program TP is executed up to the selected program instruction. By reference to the data D1, D2 it determines at least one image 15 of the workpiece 2. It outputs to the operator 10 the parameters PAR1 to PARN of the parameterized program instruction, in a form which the operator 10 can change, and the image 15. In the case when a change is made to a parameter PARn of the program instruction, it communicates the change to the CAM system 4, receives in return from the CAM system 4 changed data D1, D2, by reference to the changed data D1, D2 determines at least one amended image 15 of the workpiece 2 and outputs the amended image 15 to the operator 10. Furthermore, as soon as it has received from the operator 10 an appropriate storage command OK, it saves a modified parts program TP corresponding to the changed program instruction.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of operating a numerical controller controlling a production machine, comprising:
accessing with the numerical controller a parts program to be executed by the numerical controller,
enabling an operator to issue to the numerical controller, via an operator interface, a selection command which selects in the parts program a program instruction having at least one assigned parameter,
when the parts program is executed by the numerical controller, converting the selected program instruction into a processing movement of a tool that processes a workpiece, with the processing movement depending on the at least one assigned parameter,
determining with the numerical controller at least one image of the workpiece based on data that specify at least the three-dimensional geometry of the workpiece,
outputting with the numerical controller to the operator of the numerical controller via the operator interface the at least one assigned parameter in a form that can be changed by the operator, as well as the image,
determining with the numerical controller, when an assigned parameter is changed by the operator, at least one changed image of the workpiece based on changed data that specify at least the changed three-dimensional geometry of the workpiece, and outputting the changed image to the operator of the numerical controller via the operator interface,
upon receiving from the operator a corresponding storage command, storing with the numerical controller a modified parts program that corresponds to the changed assigned parameter,
transmitting, with the numerical controller, information (ident) which identifies the selected program instruction via a computer-to-computer link directly or indirectly to a CAM system,
receiving, at the numerical controller, from the CAM system the data that specify at least the three-dimensional geometry of the workpiece, and
transmitting, with the numerical controller, when a parameter of the selected program instruction is changed, the change to the CAM system, and receiving, at the numerical controller, from the CAM system the changed data,
wherein the data and the changed data specify the three-dimensional geometry of the workpiece that results when the parts program is executed, including the selected program instruction and the changed program instruction.

2. The method of claim 1, further comprising:
receiving at the numerical controller display parameters from the operator, and
determining with the numerical controller the image and the changed image commensurate with the display parameters.

3. The method of claim 1, wherein the data and the changed data comprise path data that describe a path of the tool processing the workpiece, and wherein the numerical controller inserts the path into the image and the changed image.

4. The method of claim 3, wherein the numerical controller additionally inserts into the image the tool and moves the tool along the path.

5. The method of claim 4, wherein the numerical controller stops and resumes movement of the tool in the image or sets a speed with which the tool is moved in the image, or both, in response to control commands inputted by the operator.

6. The method of claim 5, further comprising
receiving at the numerical controller from the operator a position along the path, and
with the tool stopped in the image, with the numerical controller, positioning the tool in the image at the position received from the operator.

7. The method of claim 4, further comprising
receiving at the numerical controller from the operator a control command, and
depending on the received control command, either moving the tool in the image while keeping the display of the workpiece unchanged, or moving the workpiece in the image while keeping the display of the tool unchanged.

8. The method of claim 4, wherein by executing the parts program, the numerical controller processes a real workpiece and moves the tool in the image along the path inserted into the image commensurate with processing the real workpiece.

9. The method of claim 1, wherein the selected program instruction of the parts program is either part of a first sequence stored in the numerical controller in parameterized form, or the selected program instruction is part of a second sequence present that is present in parameterized form neither in the parts program nor in the numerical controller.

10. The method of claim 1, wherein the numerical controller, upon a change of a parameter of the selected program instruction, either immediately or only after input of a corresponding release command by the operator,
communicates the change to the CAM system,
receives the changed data from the CAM system,
determines the changed image of the workpiece, and
outputs the changed image to the operator of the numerical controller.

11. A computer program having machine code is stored on a non-transitory computer-readable medium, wherein the machine code when loaded into a memory of a numerical controller and executed by the numerical controller, causes the numerical controller to carry out the method of claim 1.

12. A numerical controller comprising a memory into which a computer program having machine code is stored on a non-transitory computer-readable medium is loaded, wherein the numerical controller executes the machine code, causing the numerical controller to carry out the method of claim 1.
